(19) United States
(12) Patent Application Publication
(10) Pub. No.: US 2026/0024929 A1
(43) Pub. Date: Jan. 22, 2026

(54) MULTILAYERED FLEXIBLE FLAT CABLE AND MANUFACTURING METHOD THEREOF

(71) Applicants: Avary Holding (Shenzhen) Co., Ltd., Shenzhen (CN); QingDing Precision Electronics (Huai’an) Co., Ltd., Jiangsu Province (CN); Garuda Technology Co., Ltd., New Taipei City (TW)

(72) Inventors: Dong-Mei LIU, Shenzhen (CN); Honey HOU, Shenzhen (CN); Biao LI, Shenzhen (CN)

(21) Appl. No.: 18/775,317

(22) Filed: Jul. 17, 2024

(51) Int. Cl. H01R 12/69; H01B 7/08; H01B 13/06; H01R 43/04

(52) U.S. Cl. CPC H01R 12/69; H01B 7/0838; H01B 13/06; H01R 43/04

(57) ABSTRACT

A multilayered flexible flat cable includes at least two cable units. Each of the cable units includes a plurality of wires, two insulating films, a plurality of detecting elements, a plurality of crimping terminals and a plurality of cut-off holes. The wires are arranged in parallel between the two insulating films. The detecting elements are respectively electrically connected to the wires. The crimping terminals are respectively crimped to the wires, and the crimping terminals are respectively electrically connected to the wires. The cut-off holes are respectively extended through one of the two insulating films and the wires. One of the two insulating films of one of the cable units is attached to one of the two insulating films of another one of the cable units.

### BACKGROUND

### Technical Field

The present disclosure relates to a flat cable and a manufacturing method thereof. More particularly, the present disclosure relates to a flexible flat cable with multilayered structure and a manufacturing method thereof.

### Description of Related Art

The driving energy of current new energy vehicles is provided by the power batteries. To ensure the battery performance and prevent battery damage caused by overcharging and overheating of the battery cells, cell contacting system (CCS) is commonly used to collect voltage and temperature detecting signals from each individual battery to understand the status of the vehicle battery. Then, the detecting signals are sent to the control device for analysis and processing through the battery management system (BMS).

In the conventional CCS signal collecting method of cored BMS in the new energy vehicles, flexible printed circuit (FPC) is typically used as signal collecting board to measure the information, such as voltage, current and temperature, of the battery cells. However, with the development of new energy vehicle batteries without modules (such as cell to pack; CTP or cell to chassis; CTC), the size and the length of the battery modules increase. The length requirement for FPC signal collecting boards matching the battery modules reaches over 1.8 m. Due to the limitations of manufacturing process and equipment, it is challenging to produce and install extremely long FPC. Therefore, the method of using flexible flat cable (FFC) instead of FPC has been developed, which is simpler in manufacturing process, lower in cost and has the length not limited by the equipment and manufacturing process. The aforementioned method has been widely applied in some battery modules.

One conventional FFC can only match one battery assembly, and the number of individual batteries that can be detected within a certain horizontal space is limited. However, the voltage range of new energy vehicle voltage platform systems is continuously increasing, which is from the original voltage of 400 V to over 800 V. The voltage of the voltage platform systems is related to the number of cells in series in the battery pack. For example, when there are 100 cells in series in a ternary lithium battery pack, a high voltage of around 400 V is generated. If a voltage of 800 V is required, it needs about 200 ternary lithium battery cells to be connected in series, and the number of battery cells in the battery pack is doubled. When collecting signals from the battery cells of high-voltage (such as 800 V) large battery packs, more horizontally distributed FFCs are required. It occupies more space and needs more connectors to connect the signal wires of FFCs to the control device, resulting in excessive costs.

The conventional FFCs are usually made by the slitting method. The sampling strips are directly separated, folded and cut to an appropriate length. Then, the strips are welded to conductive sheets to connect the battery cells for sampling. The manufacturing process thereof is complex, and the folded area is prone to fatigue, which results in sampling failures and further causes the malfunction problem of the battery module.

### SUMMARY

According to one aspect of the present disclosure, a multilayered flexible flat cable includes at least two cable units. Each of the at least two cable units includes a plurality of wires, two insulating films, a plurality of detecting elements, a plurality of crimping terminals and a plurality of cut-off holes. The plurality of wires are arranged in parallel between the two insulating films. At least one of the two insulating films includes a plurality of connecting end holes and a plurality of crimping end holes. The plurality of crimping end holes are respectively corresponding to a plurality of ends of the plurality of wires. The plurality of connecting end holes are respectively corresponding to the plurality of wires and keep a distance from the plurality of crimping end holes. The plurality of detecting elements are respectively electrically connected to the plurality of wires through the plurality of connecting end holes. Each of the plurality of detecting elements includes a connecting element and a busbar. The connecting element includes a first end and a second end opposite to each other, and the first end is electrically connected to one of the plurality of wires. The busbar is electrically connected to the second end of the connecting element. The plurality of crimping terminals are respectively crimped to the plurality of wires through the plurality of crimping end holes, and the plurality of crimping terminals are respectively electrically connected to the plurality of wires. The plurality of cut-off holes are respectively extended through one of the two insulating films and the plurality of wires. The connecting end hole is arranged between the crimping end hole and the cut-off hole corresponding to each one of the plurality of wires. One of the two insulating films of one of the at least two cable units is attached to one of the two insulating films of another one of the at least two cable units.

According to another aspect of the present disclosure, a manufacturing method of a multilayered flexible flat cable includes the steps as follows. A plurality of first wires and a plurality of second wires are arranged between two insulating films, and the plurality of first wires and the plurality of second wires keep a distance. At least one of the two insulating films are punched in so as to form a plurality of connecting end holes and a plurality of crimping end holes, and the plurality of connecting end holes and the plurality of crimping end holes extend from the at least one of the two insulating films to the plurality of first wires or the plurality of second wires. The plurality of first wires and the plurality of second wires are punched in so as to form a plurality of cut-off holes, and the plurality of cut-off holes respectively extend through the plurality of first wires and the plurality of second wires. A plurality of crimping terminals are made to be respectively crimped to the plurality of first wires or the plurality of second wires through the plurality of crimping end holes. The two insulating films are folded to make the plurality of first wires and the plurality of second wires be overlapped. A plurality of detecting elements are made to be respectively connected to the plurality of first wires or the plurality of second wires through the plurality of connecting end holes. The two insulating films are stuck to make the two insulating films be fixed to a folding state and form the multilayered flexible flat cable.

According to one another aspect of the present disclosure, a manufacturing method of a multilayered flexible flat cable includes the steps as follows. A plurality of first wires are arranged between two first insulating films so as to form a first wire unit. A plurality of second wires are arranged between two second insulating films so as to form a second wire unit. One of the two first insulating films and one of the two second insulating films are punched in so as to form a plurality of connecting end holes and a plurality of crimping end holes, and the plurality of connecting end holes and the plurality of crimping end holes extend from the one of the two first insulating films to the plurality of first wires, or extend from the one of the two second insulating films to the plurality of second wires. The plurality of first wires and the plurality of second wires are punched in so as to form a plurality of cut-off holes, and the plurality of cut-off holes respectively extend through the plurality of first wires and the plurality of second wires. A plurality of crimping terminals are made to be respectively crimped to the plurality of first wires or the plurality of second wires through the plurality of crimping end holes. A plurality of detecting elements are made to be respectively connected to the plurality of first wires or the plurality of second wires through the plurality of connecting end holes. The first wire unit and the second wire unit are stuck to make the plurality of first wires and the plurality of second wires be overlapped and form the multilayered flexible flat cable.

### BRIEF DESCRIPTION OF THE DRAWINGS

The present disclosure can be more fully understood by reading the following detailed description of the embodiment, with reference made to the accompanying drawings as follows:

FIG. 1 is a three-dimensional structural schematic view of a multilayered flexible flat cable according to an embodiment of the present application.

FIG. 2A is a bottom schematic view of the multilayered flexible flat cable of FIG. 1.

FIG. 2B is a bottom schematic view of a multilayered flexible flat cable according to another embodiment of the present disclosure.

FIG. 3 is a step flow chart of a manufacturing method of a multilayered flexible flat cable according to one another embodiment of the present disclosure.

FIG. 4A, FIG. 4B, FIG. 4C and FIG. 4D are top schematic views of each step of the manufacturing method of the multilayered flexible flat cable.

FIG. 5 is a step flow chart of a manufacturing method of a multilayered flexible flat cable according to still another embodiment of the present disclosure.

FIG. 6A, FIG. 6B and FIG. 6C are top schematic views of each step of the manufacturing method of the multilayered flexible flat cable.

### DETAILED DESCRIPTION

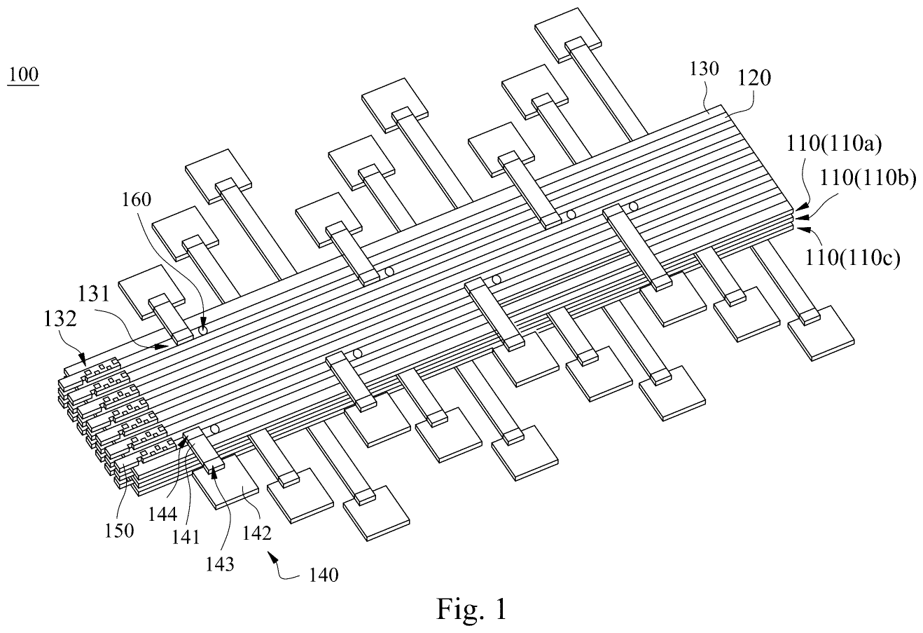

Reference is made to FIG. 1. FIG. 1 is a three-dimensional structural schematic view of a multilayered flexible flat cable 100 according to an embodiment of the present application. The multilayered flexible flat cable 100 includes at least two cable units 110. In FIG. 1, three cable units 110 are taken as an example. The three cable units 110 can respectively be a first cable unit 110a, a second cable unit 110b and a third cable unit 110c, which can have the same or similar structures. Therefore, only the structure of one of the at least two cable units 110 is explained in the follows, and the repeated details will not be given herein.

In detail, each of the at least two cable units 110 includes a plurality of wires 120, two insulating films 130, a plurality of detecting elements 140, a plurality of crimping terminals 150 and a plurality of cut-off holes 160. The plurality of wires 120 are arranged in parallel between the two insulating films 130, and adjacent two of the wires 120 keep a distance therebetween so as to prevent the interference of electrical conduction between different wires 120.

At least one of the two insulating films 130 includes a plurality of connecting end holes 131 and a plurality of crimping end holes 132. That is, the plurality of connecting end holes 131 and the plurality of crimping end holes 132 can be respectively arranged on any one of the two insulating films 130 according to the requirements. The plurality of crimping end holes 132 are respectively corresponding to a plurality of ends (its number is omitted) of the plurality of wires 120 to make the plurality of crimping end holes 132 all be arranged on one side of the multilayered flexible flat cable 100, which is favorable for subsequent installation of the terminals of the multilayered flexible flat cable 100. The plurality of connecting end holes 131 are respectively corresponding to the plurality of wires 120 and keep a distance from the plurality of crimping end holes 132. It should be mentioned that, by arranging the plurality of connecting end holes 131 and the plurality of crimping end holes 132, a portion of the plurality of wires 120 can be exposed from the two insulating films 130, which is favorable for subsequent connection with other elements.

The plurality of detecting elements 140 are respectively electrically connected to the plurality of wires 120 through the plurality of connecting end holes 131. The plurality of detecting elements 140 are configured for detecting the information, such as temperature, voltage or current, of the battery cell. Moreover, each of the plurality of detecting elements 140 includes a connecting element 141 and a busbar 142. The connecting element 141 includes a first end 143 and a second end 144 opposite to each other, and the first end 143 is electrically connected to one of the plurality of wires 120. The connecting element 141 can be FPC or flexible die-cut circuit (FDC), and the connecting element 141 can be connected to the plurality of wires 120 by welding. The busbar 142 is electrically connected to the second end 144 of the connecting element 141, and can be connected to the second end 144 by welding. A material of the busbar 142 can be aluminum, and the busbar 142 can be connected to an external battery cell which is to be detected to detect the information, such as temperature, voltage or current. The aforementioned welding can be soldering, laser welding, ultrasonic welding or surface mounting technology (SMT) welding.

Furthermore, the connecting element 141 can include a buffer portion (not shown), and the buffer portion can be a wave shape or a helix shape, and can be a groove shape. Each of the plurality of detecting elements 140 can further include a fuse element (not shown), which is arranged at the buffer portion. Also, the fuse element is electrically connected to the one of the plurality of wires 120 and the busbar 142 so as to prevent the battery cell continuing to discharge under abnormal conditions such as short circuit of the multilayered flexible flat cable 100 circuit, short circuit of the external detecting circuit and hardware damage of the external balancing circuit, which provides a protection on the battery cell and the battery pack.

A length of the fuse element can be 6 mm to 12 mm, and a width of the fuse element can be 150 μm to 250 μm. The fuse element can be manufactured by etching, and the length and width of the fuse element can be adjusted according to the maximum current which the circuit can withstand.

The plurality of crimping terminals 150 are respectively crimped to the plurality of wires 120 through the plurality of crimping end holes 132, and the plurality of crimping terminals 150 are respectively electrically connected to the plurality of wires 120. By crimping, the connection of the crimping terminals 150 and the wires 120 can be rapidly achieved so as to enhance the manufacturing efficiency. The plurality of crimping terminals 150 can be prick-type crimping terminals, and can be directly plugged into an external connector during installation without welding. Therefore, the problem of the connecting point, which is connected by a conventional welding method, breaks under a long-term high-vibration environment of the vehicle can be prevented.

The plurality of cut-off holes 160 are respectively extended through one of the two insulating films 130 and the plurality of wires 120, and the connecting end hole 131 is arranged between the crimping end hole 132 and the cut-off hole 160 corresponding to each one of the plurality of wires 120 so as to cut off the invalid circuit of the plurality of wires 120. In detail, the shapes of the plurality of cut-off holes 160 can be circles or rectangles. If the shapes are circles, it is convenient for manufacturing, and the plurality of cut-off holes 160 can be formed by laser or SMT method. A distance between the connecting end hole 131 and the cut-off hole 160 corresponding to each one of the plurality of wires 120 can be 8 mm to 12 mm, and can be 10 mm.

One of the two insulating films 130 of one of the at least two cable units 110 is attached to one of the two insulating films 130 of another one of the at least two cable units 110, which makes the at least two cable units 110 be arranged in stacks. In FIG. 1, the second cable unit 110b can be held between the first cable unit 110a and the third cable unit 110c so as to form a structure of the three cable units 110 stack sequentially.

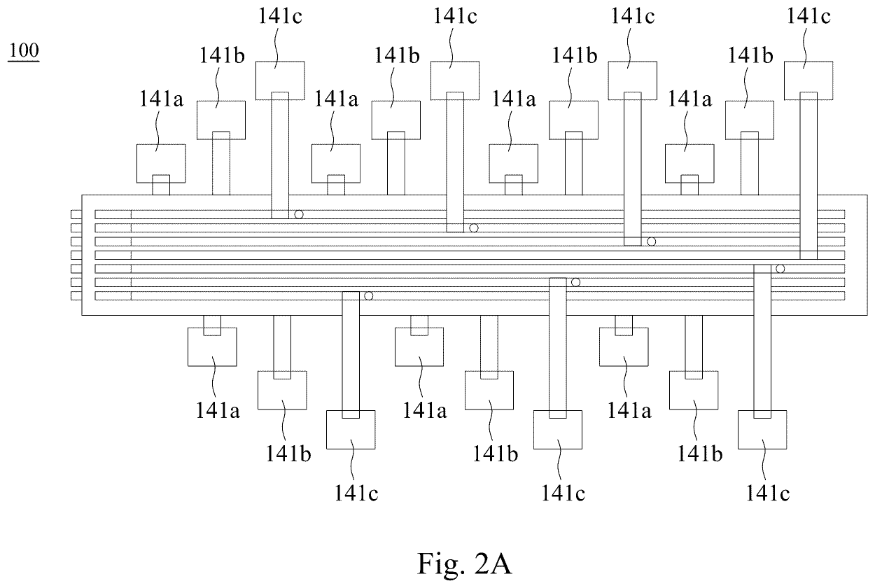

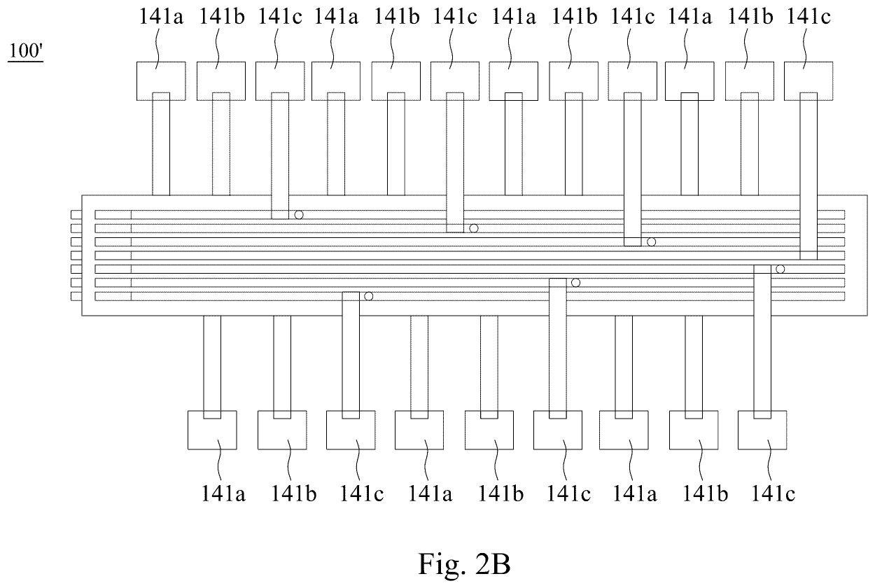

Reference is made to FIG. 2A and FIG. 2B. FIG. 2A is a bottom schematic view of the multilayered flexible flat cable 100 of FIG. 1. FIG. 2B is a bottom schematic view of a multilayered flexible flat cable 100′ according to another embodiment of the present disclosure. A length of the connecting element 141 of one of the at least two cable units 110 and a length of the connecting element 141 of another of the at least two cable units 110 can be the same or different, and the numbers thereof can also be different. In FIG. 2A, when the first cable unit 110a, the second cable unit 110b and the third cable unit 110c are connected to different battery assemblies, the lengths of the connecting elements 141a, 141b, 141c can be adjusted according to the positions of the different battery assemblies. For example, the connecting element 141a can be the shortest, the connecting element 141b can be the second shortest and the connecting element 141c can be the longest, which forms a structure with increasing lengths shown in FIG. 2A. Furthermore, in FIG. 2B, when the first cable unit 110a, the second cable unit 110b and the third cable unit 110c are all connected to the same battery assembly, the connecting elements 141a, 141b, 141c thereof can have the same lengths, and the numbers of the connecting elements 141a, 141b, 141c can be the same. Therefore, the present disclosure is not limited to the length of the connecting element 141.

The connection between the multilayered flexible flat cable 100 and a circuit board of an external device can be achieved by plugging the plurality of crimping terminals 150 into the external connector. The external connector can include slots with a number of layers corresponding to the number of the cable units 110 of the multilayered flexible flat cable 100. Also, the pitch value thereof can be decided according to the distance between the plurality of wires 120. For example, it can be three-layered slots and the pitch value can be 2 mm, and the present disclosure is not limited to the aforementioned number of layers or pitch values. By the connecting method of plugging the crimping terminals 150 into the external connector, the number of connectors can be reduced, the manufacturing process can be simplified and the usage of materials can be reduced. The installation efficiency can be simultaneously enhanced, which improves the safety and efficiency of the multilayered flexible flat cable 100 connecting the external devices and reduces the cost.

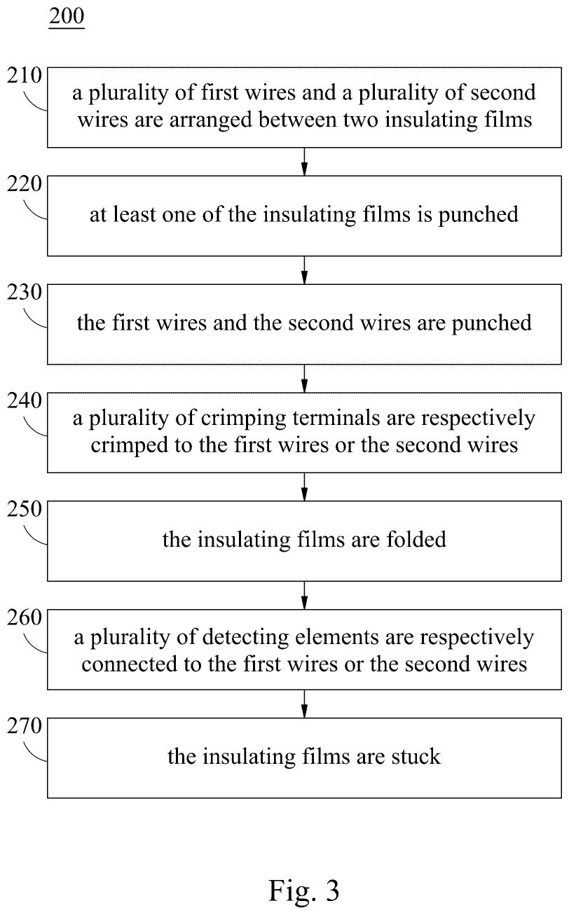

Reference is made to FIG. 3. FIG. 3 is a step flow chart of a manufacturing method of a multilayered flexible flat cable 200 according to one another embodiment of the present disclosure. The manufacturing method of the multilayered flexible flat cable 200 includes Step 210, Step 220, Step 230, Step 240, Step 250, Step 260 and Step 270.

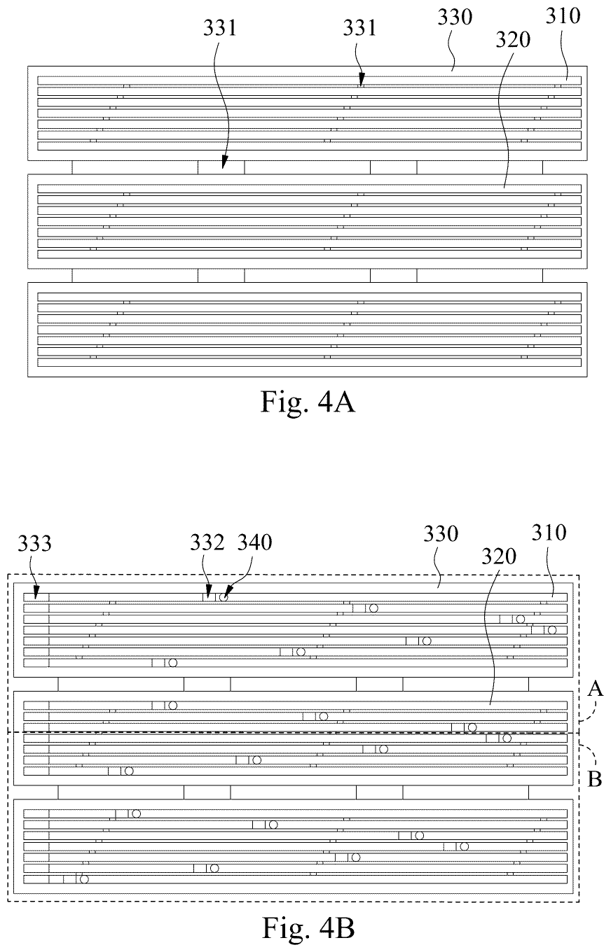

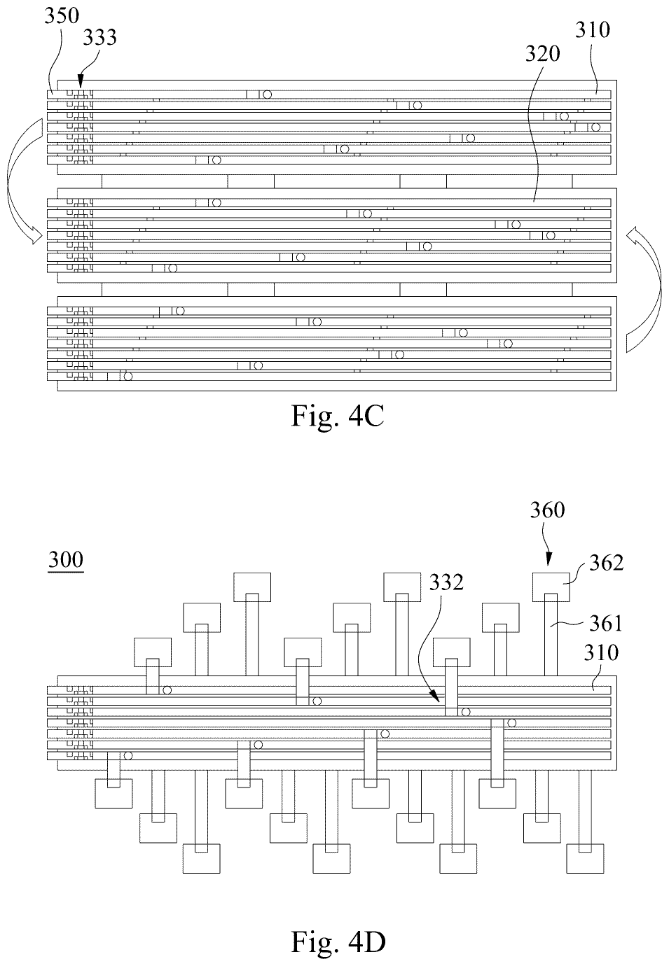

Reference is made to FIG. 4A to FIG. 4D. FIG. 4A, FIG. 4B, FIG. 4C and FIG. 4D are top schematic views of each step of the manufacturing method of the multilayered flexible flat cable 200. Step 210 is to arrange a plurality of first wires 310 and a plurality of second wires 320 between two insulating films 330, and the plurality of first wires 310 and the plurality of second wires 320 keep a distance so as to form the structure shown in FIG. 4A. The two insulating films 330 can include a plurality of tear-preventing holes 331, arranged between adjacent two of the plurality of first wires 310, between adjacent two of the plurality of second wires 320 or between the plurality of first wires 310 and the plurality of second wires 320. By arranging the tear-preventing holes 331, it can prevent the insulating films 330 from breaking due to bending.

Step 220 is to punch in at least one of the two insulating films 330 so as to form a plurality of connecting end holes 332 and a plurality of crimping end holes 333, and the plurality of connecting end holes 332 and the plurality of crimping end holes 333 extend from the at least one of the two insulating films 330 to the plurality of first wires 310 or the plurality of second wires 320. It makes a portion of the plurality of first wires 310 and the plurality of second wires 320 be exposed from the two insulating films 330, which is favorable for subsequent connection with other elements.

It should be mentioned that, the plurality of connecting end holes 332 and the plurality of crimping end holes 333 can be respectively arranged on any one of the two insulating films 330 according to the subsequent way of folding the two insulating films 330 or the position of connecting other elements. For example, in FIG. 4B, the plurality of connecting end holes 332 and the plurality of crimping end holes 333 of area A are arranged on one of the two insulating films 330, and the plurality of connecting end holes 332 and the plurality of crimping end holes 333 of area B are arranged on the other one of the two insulating films 330. Therefore, the present disclosure is not limited to the positions of the plurality of connecting end holes 332 and the plurality of crimping end holes 333.

Step 230 is to punch in the plurality of first wires 310 and the plurality of second wires 320 so as to form a plurality of cut-off holes 340, and the plurality of cut-off holes 340 respectively extend through the plurality of first wires 310 and the plurality of second wires 320 so as to form the structure shown in FIG. 4B. The connecting end hole 332 is arranged between the crimping end hole 333 and the cut-off hole 340 corresponding to each one of the plurality of first wires 310 and the plurality of second wires 320 so as to cut off the invalid circuit of the plurality of first wires 310 and the plurality of second wires 320. The shape, size and manufacturing method of the plurality of cut-off holes 340 are explained in the foregoing paragraphs, and the details will not be given again herein.

Step 240 is to make a plurality of crimping terminals 350 be respectively crimped to the plurality of first wires 310 or the plurality of second wires 320 through the plurality of crimping end holes 333. The plurality of crimping terminals 350 are respectively electrically connected to the plurality of first wires 310 or the plurality of second wires 320. By crimping, the arrangement of the crimping terminals 350 can be rapidly achieved so as to enhance the manufacturing efficiency.

Step 250 is to fold the two insulating films 330 to make the plurality of first wires 310 and the plurality of second wires 320 be overlapped. The folding way can be the same as that shown in FIG. 4C, and the two insulating films 330 are folded along a folding line which is a portion thereof without arranging the plurality of first wires 310 and the plurality of second wires 320.

Step 260 is to make a plurality of detecting elements 360 be respectively connected to the plurality of first wires 310 or the plurality of second wires 320 through the plurality of connecting end holes 332 so as to form the structure shown in FIG. 4D. In detail, each of the plurality of detecting elements 360 includes a connecting element 361 and a busbar 362. During the installation of the plurality of detecting elements 360, the connecting element 361 is first welded to the plurality of first wires 310 or the plurality of second wires 320, and the busbar 362 is welded to the connecting element 361. The detailed structure and size of the plurality of detecting elements 360 are explained in the foregoing paragraphs, and the details will not be given again herein.

Step 270 is to stick the two insulating films 330 to make the two insulating films 330 be fixed to a folding state and form the multilayered flexible flat cable 300. In detail, after coating an adhesive (such as polyethylene terephthalate; PET), it can be compressed to form the multilayered flexible flat cable 300, and aerogel or foam can be arranged between the layers of the multilayered flexible flat cable 300 as a cushion material.

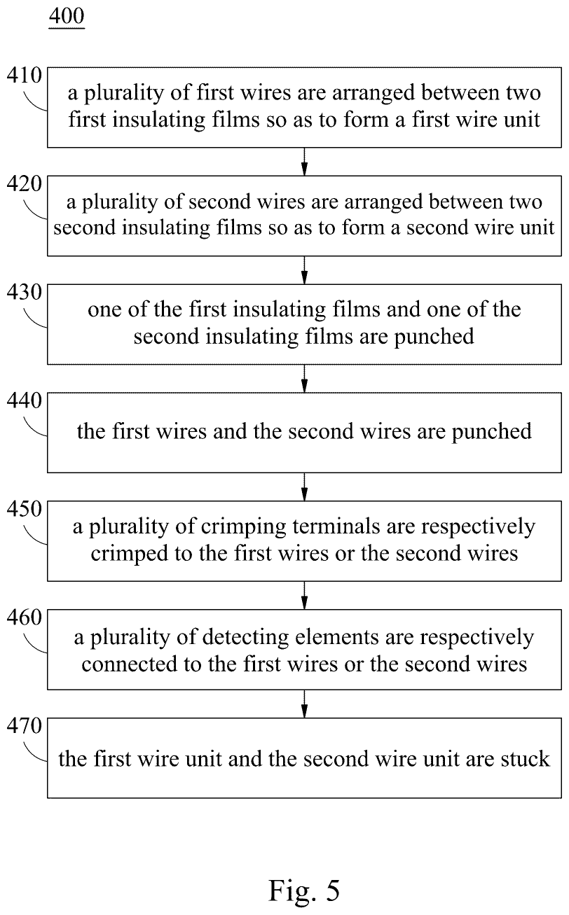

Reference is made to FIG. 5. FIG. 5 is a step flow chart of a manufacturing method of a multilayered flexible flat cable 400 according to still another embodiment of the present disclosure. The manufacturing method of the multilayered flexible flat cable 400 includes Step 410, Step 420, Step 430, Step 440, Step 450, Step 460 and Step 470.

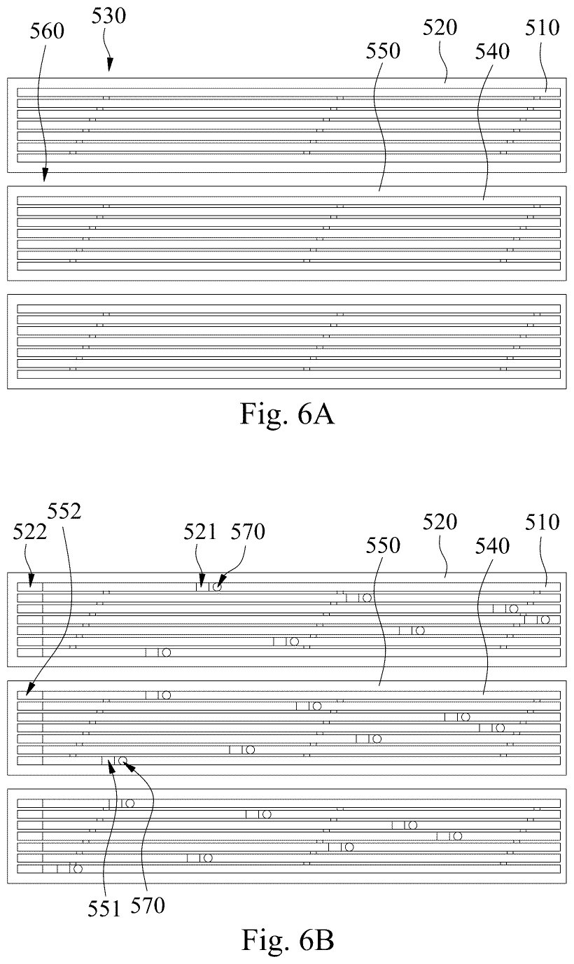

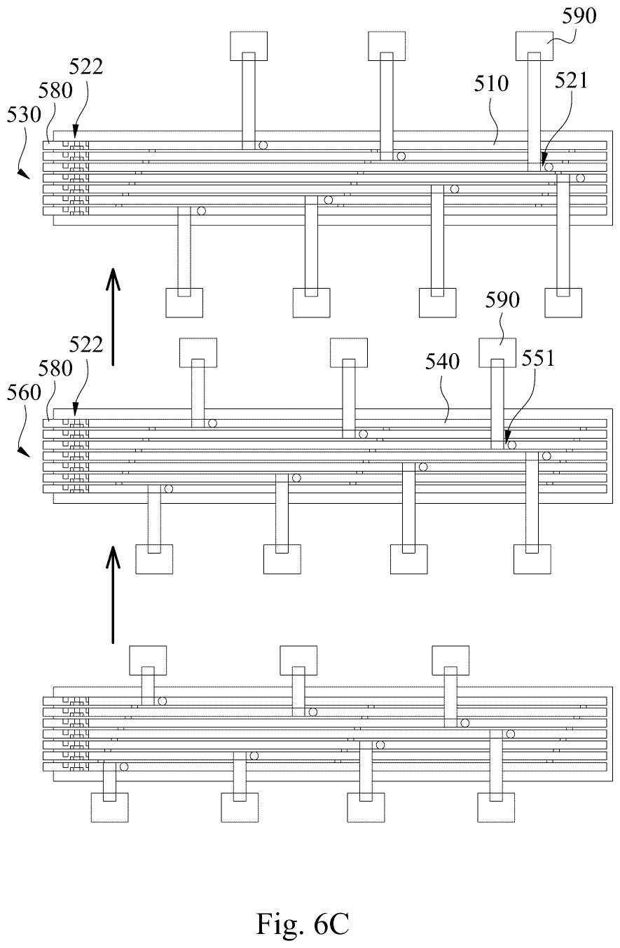

Reference is made to FIG. 6A to FIG. 6C. FIG. 6A, FIG. 6B and FIG. 6C are top schematic views of each step of the manufacturing method of the multilayered flexible flat cable 400. In FIG. 6A, Step 410 is to arrange a plurality of first wires 510 between two first insulating films 520 so as to form a first wire unit 530. Step 420 is to arrange a plurality of second wires 540 between two second insulating films 550 so as to form a second wire unit 560.

Step 430 is to punch in one of the two first insulating films 520 and one of the two second insulating films 550 so as to form a plurality of connecting end holes 521, 551 and a plurality of crimping end holes 522, 552. The plurality of connecting end holes 521 and the plurality of crimping end holes 522 extend from the one of the two first insulating films 520 to the plurality of first wires 510, and the plurality of connecting end holes 551 and the plurality of crimping end holes 552 extend from the one of the two second insulating films 550 to the plurality of second wires 540. The plurality of connecting end holes 521, 551 and the plurality of crimping end holes 522, 552 can be arranged on the same side of the two first insulating films 520 and the two second insulating films 550. It makes the plurality of connecting end holes 521, 551 and the plurality of crimping end holes 522, 552 towards the same direction, which is favorable for subsequent processing.

Step 440 is to punch in the plurality of first wires 510 and the plurality of second wires 540 so as to form a plurality of cut-off holes 570, and the plurality of cut-off holes 570 respectively extend through the plurality of first wires 510 and the plurality of second wires 540 so as to form the structure shown in FIG. 6B.

Step 450 is to make a plurality of crimping terminals 580 be respectively crimped to the plurality of first wires 510 or the plurality of second wires 540 through the plurality of crimping end holes 522, 552.

Step 460 is to make a plurality of detecting elements 590 be respectively connected to the plurality of first wires 510 or the plurality of second wires 540 through the plurality of connecting end holes 521, 551.

It should be mentioned that, the arranging ways, arranging positions, shapes, sizes or other features of the plurality of cut-off holes 570, the plurality of crimping terminals 580 and the plurality of detecting elements 590 are explained in the foregoing paragraphs, and the details will not be given again herein.

In FIG. 6C, Step 470 is to stick the first wire unit 530 and the second wire unit 560 to make the plurality of first wires 510 and the plurality of second wires 540 be overlapped and form the multilayered flexible flat cable. In detail, after coating the adhesive, it can be compressed to form the multilayered flexible flat cable, and the cushion material can be arranged between the layers of the multilayered flexible flat cable.

It should be mentioned that, although it is explained with the manufacturing method of the multilayered flexible flat cable 200, 400 arranging the plurality of first wires 310, 510 and the plurality of second wires 320, 540, but in actual manufacturing process, a plurality sets of wires can be added according to the requirements. Also, the arrangement and processing of the plurality sets of wires can be the same as or similar to those of the plurality of first wires 310, 510 or the plurality of second wires 320, 540. Therefore, the present disclosure is not limited to the number of the wire sets of the manufacturing method of the multilayered flexible flat cable 200, 400.

In this regard, by stacking a plurality of cable units, and each of the cable units can independently detect different battery assemblies, the multilayered flexible flat cable of the present disclosure can simultaneously detect a plurality of battery assemblies without disturbing each other. In the condition of reducing volume, the number of detection can increase and the detecting efficiency can be improved so as to enhance the utilizing ratio of the space, and the cost of manufacturing and installation is reduced. Moreover, the multilayered flexible flat cable of the present disclosure uses flexible printed circuit structures which are independent from each other. It can prevent the problem of fatigue from happening under a long-term vibration condition, so the service life can increase. Moreover, the multilayered flexible flat cable of the present disclosure is connected to the external battery cell which is to be detected through the detecting element. If the detecting element breaks, it only needs to weld a new detecting element again, which reduces the cost of fixing and the difficulty of fixing.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. A multilayered flexible flat cable, comprising:
at least two cable units, wherein each of the at least two cable units comprises:
a plurality of wires;
two insulating films, wherein the plurality of wires are arranged in parallel between the two insulating films, at least one of the two insulating films comprises a plurality of connecting end holes and a plurality of crimping end holes, the plurality of crimping end holes are respectively corresponding to a plurality of ends of the plurality of wires, and the plurality of connecting end holes are respectively corresponding to the plurality of wires and keep a distance from the plurality of crimping end holes;
a plurality of detecting elements, respectively electrically connected to the plurality of wires through the plurality of connecting end holes, wherein each of the plurality of detecting elements comprises:
a connecting element, comprising a first end and a second end opposite to each other, wherein the first end is electrically connected to one of the plurality of wires; and
a busbar, electrically connected to the second end of the connecting element;
a plurality of crimping terminals, respectively crimped to the plurality of wires through the plurality of crimping end holes, wherein the plurality of crimping terminals are respectively electrically connected to the plurality of wires; and
a plurality of cut-off holes, respectively extended through one of the two insulating films and the plurality of wires, wherein the connecting end hole is arranged between the crimping end hole and the cut-off hole corresponding to each one of the plurality of wires;
wherein one of the two insulating films of one of the at least two cable units is attached to one of the two insulating films of another one of the at least two cable units.

2. The multilayered flexible flat cable of claim 1, wherein a number of the at least two cable units is three, which respectively are a first cable unit, a second cable unit and a third cable unit;
wherein the second cable unit is held between the first cable unit and the third cable unit.

3. The multilayered flexible flat cable of claim 1, wherein a distance between the connecting end hole and the cut-off hole corresponding to each one of the plurality of wires is 8 mm to 12 mm.

4. The multilayered flexible flat cable of claim 1, wherein the connecting element comprises a buffer portion, and the buffer portion is a wave shape or a helix shape.

5. The multilayered flexible flat cable of claim 4, wherein each of the plurality of detecting elements further comprises:
a fuse element, arranged at the buffer portion, wherein the fuse element is electrically connected to the one of the plurality of wires and the busbar.

6. The multilayered flexible flat cable of claim 5, wherein a length of the fuse element is 6 mm to 12 mm, and a width of the fuse element is 150 μm to 250 μm.

7. The multilayered flexible flat cable of claim 1, wherein a length of the connecting element of one of the at least two cable units and a length of the connecting element of another of the at least two cable units are different.

8. A manufacturing method of a multilayered flexible flat cable, comprising:
arranging a plurality of first wires and a plurality of second wires between two insulating films, wherein the plurality of first wires and the plurality of second wires keep a distance;
punching in at least one of the two insulating films so as to form a plurality of connecting end holes and a plurality of crimping end holes, wherein the plurality of connecting end holes and the plurality of crimping end holes extend from the at least one of the two insulating films to the plurality of first wires or the plurality of second wires;
punching in the plurality of first wires and the plurality of second wires so as to form a plurality of cut-off holes, wherein the plurality of cut-off holes respectively extend through the plurality of first wires and the plurality of second wires;
making a plurality of crimping terminals be respectively crimped to the plurality of first wires or the plurality of second wires through the plurality of crimping end holes;
folding the two insulating films to make the plurality of first wires and the plurality of second wires be overlapped;
making a plurality of detecting elements be respectively connected to the plurality of first wires or the plurality of second wires through the plurality of connecting end holes; and
sticking the two insulating films to make the two insulating films be fixed to a folding state and form the multilayered flexible flat cable.

9. The manufacturing method of the multilayered flexible flat cable of claim 8, wherein the two insulating films comprise a plurality of tear-preventing holes, arranged between adjacent two of the plurality of first wires, between adjacent two of the plurality of second wires or between the plurality of first wires and the plurality of second wires.

10. The manufacturing method of the multilayered flexible flat cable of claim 8, wherein a distance between one of the plurality of connecting end holes and one of the plurality of cut-off holes corresponding to the one of the plurality of connecting end holes is 8 mm to 12 mm.

11. The manufacturing method of the multilayered flexible flat cable of claim 8, wherein each of the plurality of detecting elements comprises:
a connecting element, comprising a first end and a second end opposite to each other, wherein the first end is electrically connected to one of the plurality of first wires or one of the plurality of second wires; and
a busbar, electrically connected to the second end of the connecting element.

12. The manufacturing method of the multilayered flexible flat cable of claim 11, wherein the connecting element comprises a buffer portion, and the buffer portion is a wave shape or a helix shape.

13. The manufacturing method of the multilayered flexible flat cable of claim 12, wherein each of the plurality of detecting elements further comprises:
a fuse element, arranged at the buffer portion, wherein the fuse element is electrically connected to the one of the plurality of first wires or the one of the plurality of second wires and the busbar.

14. The manufacturing method of the multilayered flexible flat cable of claim 13, wherein a length of the fuse element is 6 mm to 12 mm, and a width of the fuse element is 150 μm to 250 μm.

15. A manufacturing method of a multilayered flexible flat cable, comprising:
arranging a plurality of first wires between two first insulating films so as to form a first wire unit;
arranging a plurality of second wires between two second insulating films so as to form a second wire unit;
punching in one of the two first insulating films and one of the two second insulating films so as to form a plurality of connecting end holes and a plurality of crimping end holes, wherein the plurality of connecting end holes and the plurality of crimping end holes extend from the one of the two first insulating films to the plurality of first wires, or extend from the one of the two second insulating films to the plurality of second wires;
punching in the plurality of first wires and the plurality of second wires so as to form a plurality of cut-off holes, wherein the plurality of cut-off holes respectively extend through the plurality of first wires and the plurality of second wires;
making a plurality of crimping terminals be respectively crimped to the plurality of first wires or the plurality of second wires through the plurality of crimping end holes;
making a plurality of detecting elements be respectively connected to the plurality of first wires or the plurality of second wires through the plurality of connecting end holes; and
sticking the first wire unit and the second wire unit to make the plurality of first wires and the plurality of second wires be overlapped and form the multilayered flexible flat cable.

16. The manufacturing method of the multilayered flexible flat cable of claim 15, wherein a distance between one of the plurality of connecting end holes and one of the plurality of cut-off holes corresponding to the one of the plurality of connecting end holes is 8 mm to 12 mm.

17. The manufacturing method of the multilayered flexible flat cable of claim 15, wherein each of the plurality of detecting elements comprises:
a connecting element, comprising a first end and a second end opposite to each other, wherein the first end is electrically connected to one of the plurality of first wires or one of the plurality of second wires; and
a busbar, electrically connected to the second end of the connecting element.

18. The manufacturing method of the multilayered flexible flat cable of claim 17, wherein the connecting element comprises a buffer portion, and the buffer portion is a wave shape or a helix shape.

19. The manufacturing method of the multilayered flexible flat cable of claim 18, wherein each of the plurality of detecting elements further comprises:
a fuse element, arranged at the buffer portion, wherein the fuse element is electrically connected to the one of the plurality of first wires or the one of the plurality of second wires and the busbar.

20. The manufacturing method of the multilayered flexible flat cable of claim 19, wherein a length of the fuse element is 6 mm to 12 mm, and a width of the fuse element is 150 μm to 250 μm.
